(19) United States
(12) Patent Application Publication
(10) Pub. No.: US 2018/0072221 A1
(43) Pub. Date: Mar. 15, 2018

(54) PORTABLE EMERGENCY LIGHT SYSTEM

(71) Applicant: Frederick Brown, Dallas, TX (US)

(72) Inventor: Frederick Brown, Dallas, TX (US)

(21) Appl. No.: 15/705,942

(22) Filed: Sep. 15, 2017

Related U.S. Application Data
(60) Provisional application No. 62/395,199, filed on Sep. 15, 2016.

(51) Int. Cl. B60Q 1/52

(52) U.S. Cl. CPC B60Q 1/52

(57) ABSTRACT

A device and method is shown and described for the purpose of providing situational awareness to third party observers through a portable emergency light system. The system includes a casing, a power supply, a control panel, and a series of lights. The lights are configured to illuminate according to one or more elected illumination patterns. The particular patterns may represent given situations or conditions, and provide notice to observers related to a warning, caution, or defined perimeter. The sequential blinking, brightness, and coloring of the emitted light may vary. Multiple units may be connected to provide an elongated series of lights. This is ideally useful for roadside assistance and emergency personnel.

### CLAIM OF PRIORITY

This application claims the benefit of U.S. Provisional Application No. 62/395,199, filed 15 Sep. 2016. The information contained therein is hereby incorporated by reference.

### BACKGROUND

### 1. Field of the Invention

The present application relates generally to a system that provides emergency lighting for public individuals and emergency personnel.

### 2. Description of Related Art

Emergency situations occur every day throughout the world. In times of emergency, it is necessary to often cordon off a particular area or to provide visual cues to direct traffic. As emergencies occur night and day, it is important that devices used are bright enough to be seen. Common devices are reflective unlit items or items that produce light. Each of these have disadvantages that make them less than desirable.

One common unlit device used is a plastic tape to block off an area. These are often colored to be obvious in the daylight when compared to most typical natural colorings. Such colors can be a florescent of yellow or orange for example. Crime scene tape for police is a common such device. These may be seen well during the day but are less than obvious at night. At times, reflective agents are used to make them stand out in the dark. However, this reflection only occurs when light is shined on it and at appropriate angles.

An example of a device used to produce a light is a flare. Flares are typically smoky and generate a great amount of heat. The heat often results in burns on the skin or holes burned into clothing from use. They can be dangerous and difficult for people of all ages and capabilities to use. Additionally, each flare is limited in its longevity. Once used, it is gone. It has to be replaced. Furthermore, a flare is not able to be turned on and off as desired and stored for later use.

In an emergency, more communication needs to be provided than reflective products and single use flares. Each of the above items fails to adequately operate in varied lighting situations and is reusable. Additionally, communication is limited greatly in that one color, constant light, limited timing and visibility are realized by conventional methods.

Although great strides have been made with respect to emergency notification devices, considerable shortcomings remain. A new system that permits for both reflective and powered operations is needed. Additionally, a device that is reusable, safer, and able to be diverse in coloring and pattern of illumination to assist in communicating a more diverse and customized message is also needed.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a schematic of a portable emergency light system according to an embodiment of the present application

FIG. 2 is a side view of the portable emergency light system of FIG. 1

FIG. 3 is a front view of the portable emergency light system of FIG. 2.

FIG. 4 is an exemplary top view of the portable emergency light system of FIG. 3.

FIG. 5 is a representative and exemplary side section view of a casing in the portable emergency light system of FIG. 1.

FIG. 6 is a side view of the portable emergency light system of FIGS. 2-4 coupled to multiple systems.

FIG. 7 is a chart of the method of using the portable emergency light system of FIG. 1.

While the device and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with conventional emergency devices. Specifically, the portable emergency light system of the present application is configured to provide an unlimited and continuous amount of power to supply one or more lights so as to communicate a message to a remote observer. The system is configured to be selectively communicated with one or more like devices so as to reach unlimited lengths. The patterns and colors of the lights may be adjusted to convey different messages. These and other unique features of the device are discussed below and illustrated in the accompanying drawings.

The system and method will be understood as to its operation, from the accompanying drawings, taken in conjunction with the accompanying description. It should be understood that various components, parts, and features of the device may be combined together and/or interchanged with one another, all of which are within the scope of the present application, even though not all variations and particular embodiments are shown in the drawings. It should also be understood that the mixing and matching of features, elements, and/or functions is expressly contemplated herein so that one of ordinary skill in the art would appreciate from this disclosure that the features, elements, and/or functions of one embodiment may be incorporated into another embodiment as appropriate, unless otherwise described.

The system of the present application includes a casing, control panel, charging cord, and one or more lights. The lights are configured to be visible from either side of the casing. The control panel is designed to permit for the selected operation of the one or more lights. The pattern and the coloring of the lights may be selected via an optional controller. The cord is configured to provide a constant source of power from a remote power generation device. Additionally, the system may include a power supply to store and distribute power to the system.

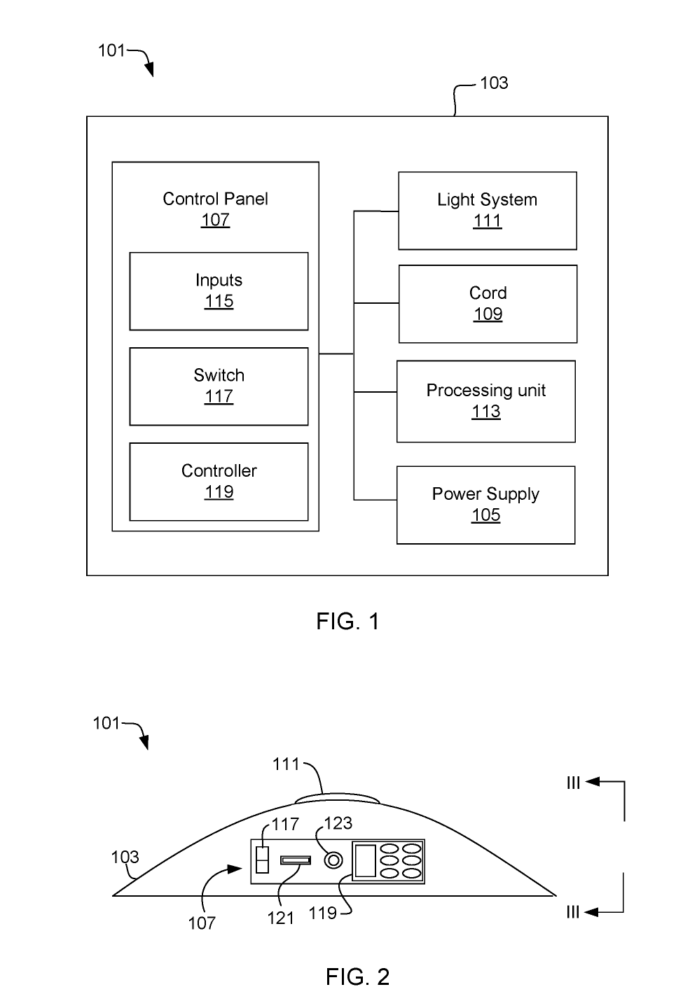

Referring now to FIG. 1 in the drawings, a schematic of a portably emergency light system 101 is illustrated. System 101 includes a casing 103, a power supply 105, a control panel 107, a cord 109, and one or more lights 111. System 101 is configured to provide safe and continuous operation of lights 111 so as to be visible to observers (third parties) at any time of day. In use, system 101 is configured to communicate situational awareness to a third party. For example, system 101 is ideal for use with police and other emergency personnel wherein they may line a perimeter with system 101, or a plurality of linked systems 101, to convey information about the situation, a warning, caution, or other message. Additionally, it is useful for the public when used alongside emergency kits in vehicles in the case of a breakdown. System 101 is ideally designed to be reusable and portable so as to selectively operate at various times and over many different instances.

The various parts and portions within control panel 107 are optionally available and included within system 101 as described below. Additionally, it is understood that cord 109 is optional. The use of a processing unit 113 is likewise optional. Each will be detailed in more particularity below.

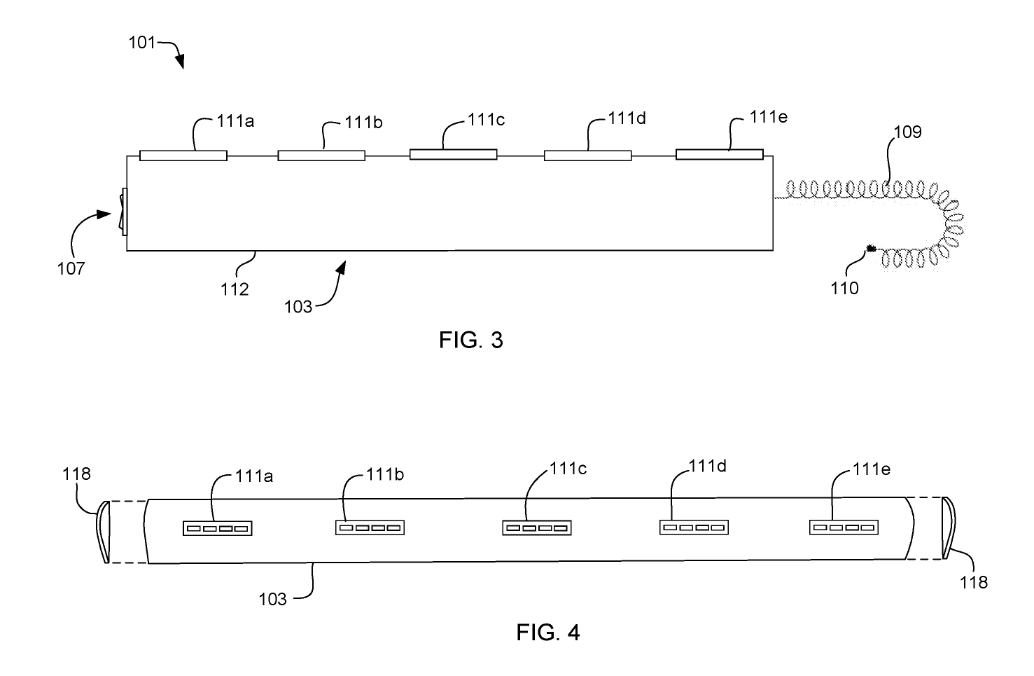

Referring now also to FIGS. 2-4 in the drawings, exemplary side, front, and top views of system 101 are illustrated. Casing 103 is configured to surround and support the operation and orientation of the respective components incorporated into system 101. Casing 103 is sufficiently hardened to add strength and durability while permitting the ability to flex so as to adapt to the contours of the ground. This hardness is sufficient to support the weight of vehicles and trucks if run over. As seen in the figures, the contour of casing 103 is designed to lessen the impact from tires by having a domed or curved outer surface. Internal workings of system 101, such as power supply 105 and processing unit 113, are located within an internal volume of casing 103.

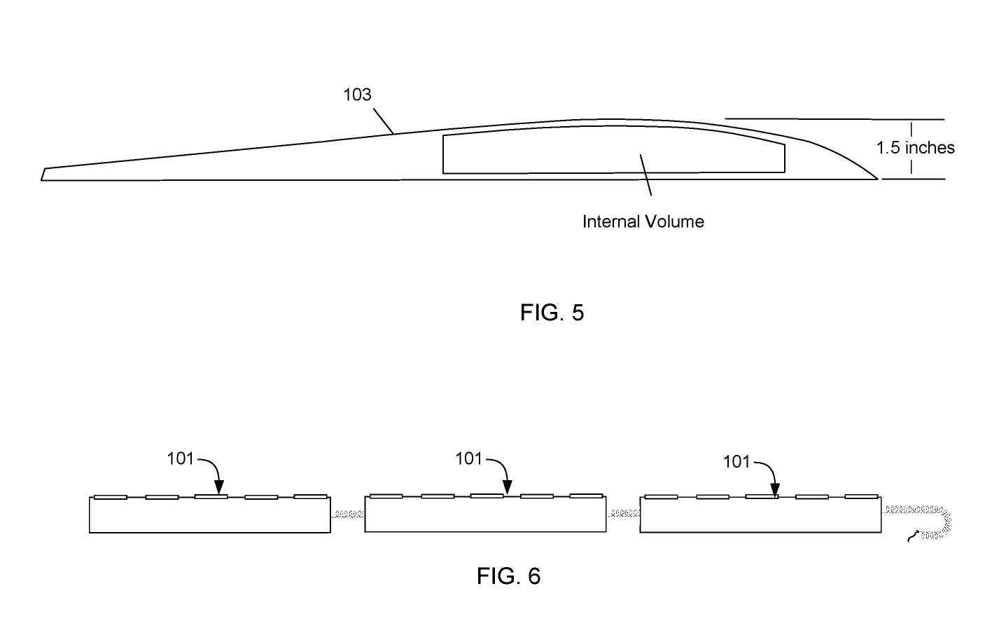

FIG. 4 is an exemplary top view of casing 103 with lights 111a-e illustrated. Casing 103 includes sides which are coupled to the main housing. The ends are ideally not removed once formed. Their removal initially is to permit the wiring and locating of the various components of system 101 within the internal volume of the housing (see FIG. 5).

Referring now also to FIG. 5 in the drawings, an alternate exemplary side view of casing 103 is illustrated. This side view illustrates casing 103 in a more streamlined and shallow profile. The profile chosen for casing 103 is not limited to the designs illustrated herein. The profile is such as to permit the gradual rolling of a vehicle over itself so as to minimize and distribute force loads. As seen in FIG. 5, the internal volume is shown. Also to note is that in this profile, the overall height of casing 103 is no greater than 1.5 inches. The precise dimensions are not meant to be limiting but serve as an example only.

The various components of system 101 are designed to operate when they receive power. System 101 is configured to supply power to the components via an internal power source (i.e. power supply 105). Power supply 105 may be an internal battery and may optionally be configured to be rechargeable. The act of recharging may be done by removing power supply 105 or by coupling a cord to a port in casing 103 for charging while power supply 105 remains internally to casing 103.

System 101 may be used completely remote to any other power generation system as seen with use when power supply is an internal batter. Alternatively, system 101 may be configured to receive power from a remote power source. This can be done through a power cord 109. An example of a remote power source is a vehicle. The remote power source may provide simultaneous power to operate system 101 and/or recharge power supply 105. Naturally, either type of method for powering system 101 may be selected, including the ability to alternate between the two methods as needed.

Cord 109 is configured to include an adapter port 110 at an end distal from casing 103 to allow it to connect with one or more different types of ports. Such example ports may be a USB port or a cigarette lighter found in a vehicle. Adapter port 110 may use an adapter to allow engagement with various types of ports. Through cord 109, power is provided to power supply 105 and system 101 in general for operation.

Although depicted as being external, it is understood that cord 109 may be selectively stored internally to casing 103 within a portion of the internal volume. This is ideal when power supply 105 is solely responsible for powering system 101. Cord 109 may be retracted via a mechanism or be manually placed within casing 103. When deployed, cord 109 provides the ability to receive power from a remote power source.

Light system 111 is a primary functional member of system 101 and includes lights 111a-e (herein after referred to as lights 111). Lights 111 (i.e. lights 111a-e) are configured to selectively illuminate so as to convey information to a third party observer. In a different way of stating it, lights 111 are configured to provide the third party observer situational awareness through its illumination pattern. This information may signal need for a service, provide warning, or even define a perimeter. The information may also give directions or direct one along a route. There are multiple different types of information that may be conveyed through the selective illumination pattern of lights 111. As seen in the figures, lights 111 are located typically at the crest of casing 103 so as to be visible from both sides. It is understood that lights 111 are able to be oriented and arranged in any pattern and direction on casing 103.

Lights 111 may be configured to illuminate in one of many types of illumination patterns. For example, lights 111 may in a continuous manner. Also, lights 111 may illuminate in a blinking pattern. The blinking pattern may allow for lights 111 to illuminate in an alternating manner wherein the order of illumination may be either continuous or alternatively it may be random. Additionally, the level of brightness may be continuous or selectively alternate between a selected range of levels. For example, lights 111 may blink between an on and off illumination simultaneously. Lights may illuminate with a random blinking illumination pattern. Additionally, lights 111 may remain on consistently but alternate between different brightness levels. It is understood that where a plurality of lights 111 are used, additional patterns of illumination may be realized by combining and timing the illumination of each light 111 with the other neighboring lights.

It is important to note that lights 111 may include one or more bulbs or light fixtures. This is useful in generating different colors to illuminate. System 101 is optionally configured to permit for the illumination of lights in one or more color patterns. Different color patterns may either be used to distinguish different emergency personnel or used and adjusted based on the situation at hand. Additionally, lights 111 may be any type of light. It is desired that for efficiency reasons, lights 111 be small, compact and efficient so as to increase battery life. An example of a suitable light may be a light emitting diode.

Processing unit 113 is configured to regulate the functions and performance of system 101. In particular, unit 113 receives input data from control panel 107 and in turn operates lights 111 in accordance with a particular illumination pattern. At its most basic form, unit 113 is configured to a single illumination pattern and/or a single color combination. Therefore if a user activates system 101, a preset illumination pattern begins. Conversely, unit 113 may optionally be configured to include one or more illumination patterns pre-stored for selection by a user. The user merely manipulates control panel 107 to select the pattern of choice. In like manner, unit 113 is also configured to permit a user to customize and program tailored illumination patterns that relate to a given situation or commonly incurred situations. The user may input these illumination patterns to unit 113 for storage and selected use. In general, the functions of lights 111 may be stored on unit 113 to be available for selection by a user via control panel 107. Settings can be deleted, input, and re-stored to permit customization by particular users.

Control Panel 107 is configured to act as a user interface in operating system 101. Control panel 107 includes many features, all of which may be optional depending on the particular needs or embodiment. For example, control panel 107 may include an on/off switch 117 configured to turn on and off system 101. The functions of switch 117 may be incorporated into controller 119 where included. Controller 119 includes one or more buttons along with a display for the operating system 101. Many types of features may be operated through controller 119. Beyond just lights 111, other types of features may be realized, such as potentially sound generation. Potential embodiments may include the ability to record and play sounds through a mic and speaker (not shown). Control panel 107 also optionally includes one or more inputs 115. Inputs 115 allow other devices to be coupled to system 101. Examples of inputs 115 may be a USB port 121 and an audio port 123.

As seen in the figures, control panel 107 is situated on an end of casing 103. This location allows a user access to control panel 107 without having to adjust the location of system 101. Locating control panel 107 on the end of casing 103 is only one location available. It is understood that some embodiments may elect to locate control panel 107 on a bottom surface 112 of the casing 103b.

It is understood that casing 103 includes a particular height and length. The length of casing 103 is not limited to any particular size. Lengths may be 12-18 inches or up to 3 to 4 feet. Referring now also to FIG. 6, it should be noted that multiple systems like system 101 may be interconnected to operate together, thereby further extending the overall effective length as each unit is linked together. For example, inputs 115 may accept cords from a neighboring system (similar to system 101), thereby interlinking the systems via control panel 107. This allows for a string of systems to be aligned as needed in multiple configurations. When combined with other systems, a dominant system is designated while other systems are made servient in nature. Therefore, collectively they act as a single system with one single system being used to control the others. The dominant system regulates the illumination pattern and sequencing of lights throughout all linked systems. Additionally, the dominant system regulates the audible production of sound through all linked systems.

Referring now back to FIG. 4, system 101 may further include a cap member 118 configured to couple to an end of casing 103. Cap member 118 is useful to cover a portion of control panel 107 to avoid contamination by dirt and debris. Cap member 118 may be configured to cover all or only a portion of control panel 107. Another use of cap member 118 is to provide protection around edges of casing 103. Cap member 118 may extend away from a surface of casing 103 so as to elevate surface 120 off the ground in case the ground is saturated with water (i.e. during a rain storm). Members 118 may be configured to detach fully and or may be hingedly coupled to casing 103.

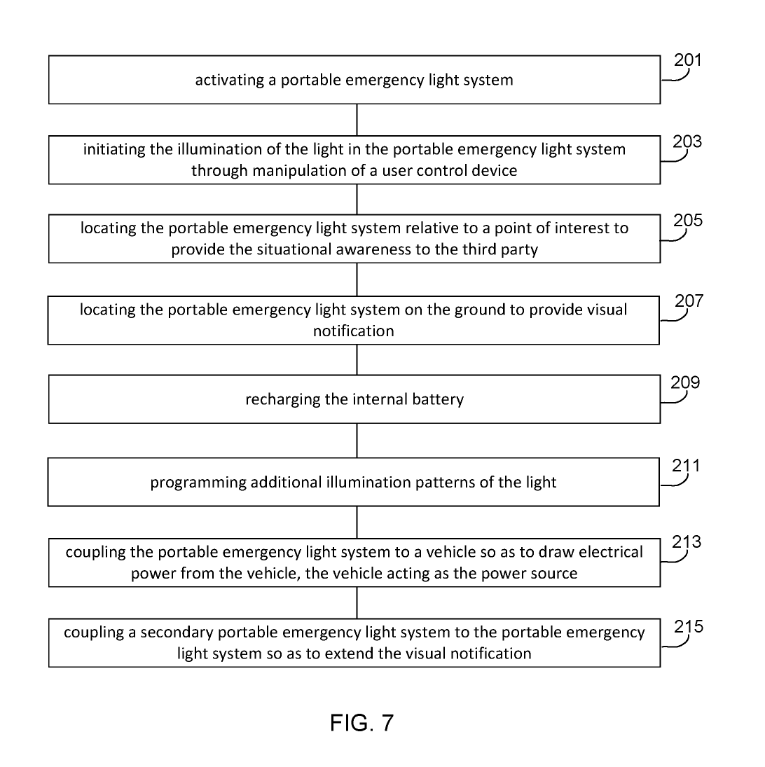

Referring now to FIG. 7 in the drawings, a chart of a method of using system 101 is illustrated. In use, an operator obtains system 101 and activates it (201). The user may elect to use a preset illumination pattern or initiate a custom illumination pattern through manipulation of the control panel (203). The user then locates the system to a desired location relative to a point of interest so as to provide situation awareness to the third party observers (205). The system is ideally suited for locating it on the ground (207) but may be elevated at any height off the ground. When the power is low, a user may elect to recharge the power supply (209). This may be done by coupling the system to a vehicle for power (213). If a particular illumination pattern is not available for a desired situation, the user is able to use the control panel to set up or program in additional illumination patterns as desired (211). The control panel also permits the linking of multiple systems together to extend the reach or length of the system (215).

Particular advantages of system 101 include at least the following: (1) the system avoids the environmental hazards of flares; (2) it's a compact and fully portable unit allowing for the continuous generation of illuminating lights; (3) it is reusable; and (4) it is customizable to work with emergency personnel and public users.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A portable emergency light system, comprising:
a casing;
a power supply located within the casing;
a light in communication with the power supply and housed in the casing;
a control panel configured to provide operational control of the light;

2. The system of claim 1, wherein the profile of the casing limited to a height no greater than 1.5 inches.

3. The system of claim 1, wherein the casing is configured to support the weight of a vehicle.

4. The system of claim 1, wherein the power supply is an internal battery.

5. The system of claim 4, wherein the battery is rechargeable.

6. The system of claim 1, further comprising:
a power cord configured to carry electrical power from a remote power source.

7. The system of claim 6, wherein the remote power source is a vehicle.

8. The system of claim 1, wherein the light is configured to operate in at least one of a continuously lit illumination pattern and a blinking illumination pattern.

9. The system of claim 1, further comprising:
a processing unit configured to regulate the performance of the light, the processing unit in communication with the light, the processing unit permitting different a plurality of illumination patterns.

10. The system of claim 9, wherein the processing unit permits user customization and user programming of the illumination patterns.

11. The system of claim 9, wherein the control panel includes a controller, the controller is configured to accept user inputs and transmit those inputs to the processing unit for operational control of the light.

12. The system of claim 1, wherein the control panel is located on a side of the casing.

13. The system of claim 12, further comprising:
a cap member configured to surround the side of the casing and cover the control panel

14. The system of claim 13, wherein the cap member is configured to elevate the casing off the ground.

15. A method of communicating situational awareness to a third party, comprising:
activating a portable emergency light system, having:
a casing;
a power supply located within the casing;
a light in communication with the power supply and housed in the casing the light being visible to the third party; and
a control panel configured to provide operational control of the light;
initiating the illumination of the light in the portable emergency light system through manipulation of a user control device; and
locating the portable emergency light system relative to a point of interest to provide the situational awareness to the third party.

16. The method of claim 15, further comprising:
locating the portable emergency light system on the ground to provide visual notification.

17. The method of claim 15, further comprising:
recharging the internal battery.

18. The method of claim 15, further comprising:
programming additional illumination patterns of the light.

19. The method of claim 15, further comprising:
coupling the portable emergency light system to a vehicle so as to draw electrical power from the vehicle, the vehicle acting as the power source.

20. The method of claim 15, further comprising:
coupling a secondary portable emergency light system to the portable emergency light system so as to extend the visual notification.
